(19) United States
(12) Patent Application Publication
(10) Pub. No.: US 2007/0087785 A1
(43) Pub. Date: Apr. 19, 2007

(54) Mobile terminal device and receiver sensitivity informing method

(75) Inventors: Daisuke Kikuchi, Yokohama-shi (JP); Yuji Arakawa, Tokyo (JP); Hiroyuki Suzuki, Tokyo (JP); Taro Sasada, Kawasaki-shi (JP)

Correspondence Address: MICHAUD-DUFFY GROUP LLP, 306 INDUSTRIAL PARK ROAD, SUITE 206, MIDDLETOWN, CT, 06457, US

(73) Assignee: NTT DoCoMo, Inc., Tokyo (JP)

(21) Appl. No.: 11/514,414

(22) Filed: Sep. 1, 2006

(30) Foreign Application Priority Data
Sep. 5, 2005 (JP) 2005-256348

(51) Int. Cl. H04B 1/38; H04M 1/00

(52) U.S. Cl. 455/558

(57) ABSTRACT

A mobile terminal device and receiver sensitivity informing method for suitably receiving an electromagnetic wave from an external reader/writer to enable a user to use service promptly and reliably. In a mobile terminal device 1 that performs communication with an external R/W 2 in a noncontact matter, when an IC card section 12 receives an electromagnetic wave from the external R/W 2, a control section 11 determines a receiver sensitivity of the device 1 corresponding to the electromagnetic wave, and an informing section 14 informs the user of a different item of content corresponding to the determined receiver sensitivity of the device 1. The informing section 14 informs the user of the content using a display 141, vibrating device 142, speaker 143, emitting device 144 or a combination thereof.

### BACKGROUND OF THE INVENTION

1. Field of the Invention

The present invention relates to a mobile terminal device and receiver sensitivity informing method, and more particularly, to a mobile terminal device provided with a proximity card function and a receiver sensitivity informing method of the device.

2. Related Background Art

Currently, mobile terminals provided with the proximity card function are widely used, and various kinds of service are provided using these mobile terminals. For example, as well as electronic payment service known as the typical service (for example, see Japanese published unexamined Application No. 2002-109427), it is made possible to perform boarding procedures of an airplane, locking and unlocking of a house, and the like. It is expected that the utilization range of the proximity card function will be expanded further in the future. Under such circumstances, it becomes an important issue how to improve the operability of the proximity card function when the function is used.

In each service as described above, in using the proximity card function of the mobile terminal, required information is exchanged between a proximity card section of the mobile terminal and an external Reader/Writer (R/W) by information communication using an electromagnetic wave transmitted from the external R/W disposed in a store or the like. Accordingly, in order to receive provision of the service with the mobile terminal, it is necessary for the proximity card section to suitably receive the electromagnetic wave from the external R/W. However, a range enabling the proximity card section to receive the electromagnetic wave is extremely limited. A problem thereby arises that unless the proximity card section is held in a predetermined position over the external R/W, it is not possible to receive the electromagnetic wave from the external R/W, and not to receive provision of the service by the mobile terminal.

In the mobile terminal, in order to enable the proximity card section to be held in the predetermined position of the external R/W section, devices are made such that a certain mark is put on an outer portion corresponding to the proximity card section and the like. However, in holding the mobile terminal over the external R/W, the mark is placed in user's blind spot, and the above-mentioned problem has not been resolved completely.

### SUMMARY OF THE INVENTION

It is an object of the present invention to provide a mobile terminal device and receiver sensitivity informing method for suitably receiving an electromagnetic wave from an external reader/writer to enable a user to use service promptly and reliably.

A mobile terminal device of the invention is a mobile terminal device that performs communication with an external reader/writer in a noncontact manner, and has a receiver that receives an electromagnetic wave from the reader/writer, a determiner that determines a receiver sensitivity of the device corresponding to the electromagnetic wave, and an informing section that informs a user of a different item of content corresponding to the receiver sensitivity of the device.

In the mobile terminal device of the invention, it is preferable that the informing section informs the content enabling a grasp of a position over the reader/writer where the receiver sensitivity of the device is the highest.

In the mobile terminal device of the invention, it is preferable that the informing section informs the content to guide the device to the position over the reader/writer where the receiver sensitivity of the device is the highest.

In the mobile terminal device of the invention, it is preferable that the informing section informs the content corresponding to a distance to the position over the reader/writer where the receiver sensitivity of the device is the highest.

In the mobile terminal device of the invention, it is preferable that the informing section has a display that displays the content corresponding to the receiver sensitivity of the device, a vibrator that vibrates corresponding to the receiver sensitivity of the device, a sound output section that outputs a sound corresponding to the receiver sensitivity of the device, an emitter that emits light corresponding to the receiver sensitivity of the device, or a combination thereof.

In the mobile terminal device of the invention, it is preferable that the device further has an input section that receives an input of operation of a user, and that the informing section informs the content using the display, vibrator, sound output section, emitter or a combination thereof, according to an instruction from the user received via the input section.

In the mobile terminal device of the invention, it is preferable that the device further has a storage that stores threshold data used in determining the receiver sensitivity of the device, and that the determiner determines the receiver sensitivity of the device based on the threshold data.

In the mobile terminal device of the invention, it is preferable that the storage stores a plurality of items of threshold data, and that the determiner determines the receiver sensitivity of the device by comparison with the plurality of items of threshold data.

A method of informing a receiver sensitivity of the invention is a method of informing a receiver sensitivity in a mobile terminal device that performs communication with an external reader/writer in a noncontact manner, where an electromagnetic wave is received from the reader/writer, a receiver sensitivity of the device is determined corresponding to the electromagnetic wave, and a user is informed of a different item of content corresponding to the receiver sensitivity of the device.

In the method of informing a receiver sensitivity of the invention, it is preferable that informed is the content enabling a grasp of a position over the reader/writer where the receiver sensitivity of the device is the highest.

In the method of informing a receiver sensitivity of the invention, it is preferable that informed is the content to guide the device to the position over the reader/writer where the receiver sensitivity of the device is the highest.

In the method of informing a receiver sensitivity of the invention, it is preferable that informed is the content corresponding to a distance to the position over the reader/writer where the receiver sensitivity of the device is the highest.

In the method of informing a receiver sensitivity of the invention, it is preferable that the content is informed using a display that displays the content corresponding to the receiver sensitivity of the device, a vibrator that vibrates corresponding to the receiver sensitivity of the device, a sound output section that outputs a sound corresponding to the receiver sensitivity of the device, an emitter that emits light corresponding to the receiver sensitivity of the device, or a combination thereof.

In the method of informing a receiver sensitivity of the invention, it is preferable that the content is informed using the display, vibrator, sound output section, emitter or a combination thereof, according to an instruction received from the user.

In the method of informing a receiver sensitivity of the invention, it is preferable that threshold data used in determining the receiver sensitivity of the device is stored, and that the receiver sensitivity of the device is determined based on the threshold data.

In the method of informing a receiver sensitivity of the invention, it is preferable that a plurality of items of threshold data is stored, and that the receiver sensitivity of the device is determined by comparison with the plurality of items of threshold data.

### BRIEF DESCRIPTION OF THE DRAWINGS

The various features of novelty which characterize the invention are pointed out with particularity in the claims attached to and forming a part of this specification. For a better understanding of the invention, its operating advantages, and specific objects attained by its use, reference should be had to the accompanying drawing and descriptive matter in which there is illustrated and described a preferred embodiment of the invention.

FIG. 1 is a diagram illustrating a schematic configuration of a service providing system using a proximity card function of a mobile terminal device according to one embodiment of the invention;

FIG. 2 is a diagram illustrating a schematic configuration of the mobile terminal device according to the above-mentioned embodiment;

FIG. 3 is a diagram showing an example of an informing data table managed in a storage section of the mobile terminal device according to the above-mentioned embodiment;

FIG. 4 is a sequence diagram to explain processing for informing a user of a receiver sensitivity in the mobile terminal device according to the above-mentioned embodiment;

FIG. 5 is a diagram illustrating an appearance of an external R/W according to the above-mentioned embodiment;

FIGS. 6A, 6B, 6C are diagram illustrating an appearance of the mobile terminal device that is closed where each of various items of content of informing is displayed in a sub-display according to the above-mentioned embodiment; and

FIG. 7 is another diagram illustrating an appearance of the mobile terminal device that is closed where a modification of the content of informing is displayed in the sub-display according to the above-mentioned embodiment.

### DETAILED DESCRIPTION OF THE PREFERRED EMBODIMENTS

An embodiment of the present invention will specifically be described below with reference to accompanying drawings. In addition, a mobile terminal device and receiver sensitivity informing method according to the invention are to improve efficiency in communicating information with the external R/W before receiving provision of service when receiving the provision of service using the proximity card function of the mobile terminal device. The invention is thereby applicable to any kinds of service using the proximity card function.

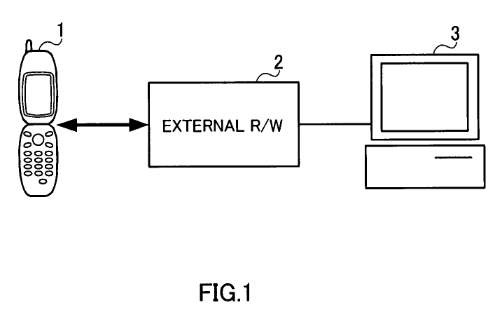

FIG. 1 is a diagram illustrating a schematic configuration of a service providing system using the proximity card function of a mobile terminal device according to one embodiment of the invention. The system as shown in FIG. 1 is mainly comprised of a mobile terminal (cellular telephone) 1 according to the invention, external R/W 2 disposed in a store or the like of a service provider that provides the mobile terminal 1 with service, and a service providing apparatus 3 connected to the external R/W 2. The service providing apparatus 3 exchanges required information by information communication using the proximity card function of the mobile terminal 1, and then, provides the mobile terminal 1 with various kinds of service such as electronic payment service and the like.

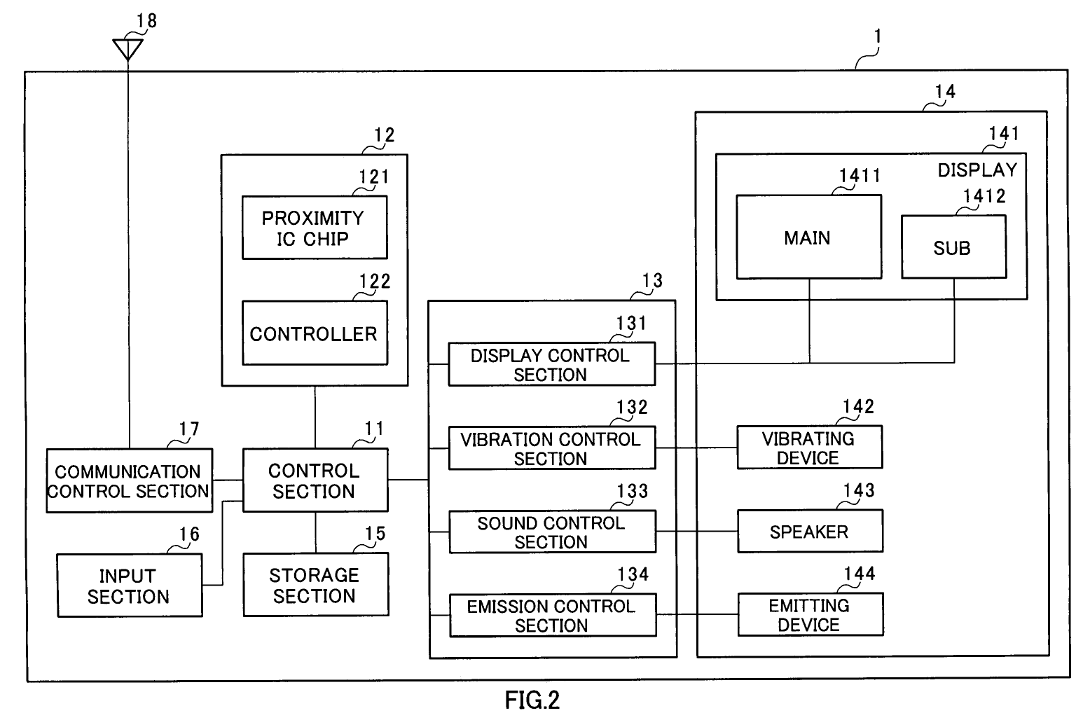

The mobile terminal 1 as shown in FIG. 1 has a configuration as shown in FIG. 2. FIG. 2 is a diagram illustrating a schematic configuration of the mobile terminal device according to one embodiment of the invention. In addition, the configuration as shown in FIG. 2 is simplified to explain the invention, and is assumed to have structural components installed in a typical mobile terminal device. Described herein is a case where the mobile terminal 1 has a flip-phone shape, and the proximity card function is FeliCa (Trademark).

The mobile terminal 1 includes a control section 11 that controls the entire device, an IC card section 12 to implement the proximity card function, an informing control section 13 that performs control (hereinafter, referred to as “informing control”) to inform a user of an item of content corresponding to the receiver sensitivity in the mobile terminal 1, an informing section 14 that informs the user of the content corresponding to the receiver sensitivity in the mobile terminal 1 using characters, image, vibration, sound and/or light subjected to informing control, a storage section 15 that stores a table (hereinafter, referred to as an “informing data table”) of data (hereinafter, referred to as “informing data”) to designate a form and content of informing, an input section 16 that receives a new input of informing data, instructions for update of the data and the like from the user, a communication control section 17 that controls communication with the external R/W 2, network and the like, and an antenna 18.

The IC card section 12 has a proximity IC chip 121 that buffers FeliCa content, and a controller (FeliCa operating system) 122 to implement the proximity card function. The informing control section 13 has a display control section 131 that controls display used in the mobile terminal 1, a vibration control section 132 that controls vibration used in the mobile terminal 1, a sound control section 133 that controls a sound used in the mobile terminal 1, and an emission control section 134 that controls light emission used in the mobile terminal 1. The informing section 14 has a display 141 that displays characters, image and video subjected to display control, a vibrating device 142 that vibrates corresponding to vibration control, a speaker 143 that outputs a sound (including melody) subjected to sound control, and an emitting device 144 that emits light corresponding to emission control.

The display 141 has a main display 1411 constituting a main screen of the mobile terminal 1, and a sub-display 1412 constituting a sub-screen of the terminal 1. The main display 1411 is assumed to be driven when the mobile terminal 1 is opened, and the sub-display 1412 is assumed to be driven when the mobile terminal 1 is closed. The emitting device 144 has a configuration enabling light emission of a plurality of colors. Herein, the device 144 is configured to be able to emit two colors, red and blue.

The IC card section 12 performs proximity card communication with the external R/W 2. In other words, when the IC card section 12 receives an electromagnetic wave transmitted from the external R/W 2, the electromagnetic wave causes a current to flow through a coil of the IC card section 12, the controller 122 is thereby activated, and the IC card section 12 becomes usable. Then, in this activated state, it is possible to acquire various kinds of information (for example, FeliCa content) from the external R/W 2. Thus acquired various kinds of information are buffered in the proximity IC chip 121 when necessary.

The control section 11 functions as a determiner, determines the receiver sensitivity in the mobile terminal 1 determined corresponding to the electromagnetic wave transmitted from the external R/W 2, and notifies the informing control section 13 of the content of informing corresponding to the determination result. The control section 11 monitors an amount of current passed through the coil of the IC card section 12 corresponding to the electromagnetic wave transmitted from the external R/W 2 to compare with predetermined threshold data (data of the current amount), and thereby determines the receiver sensitivity in the mobile terminal 1. Further, in notifying the informing control section 13 of the content of informing corresponding to the determination result, the control section 11 selects one of the control sections 131 to 134 in the informing control section 13 corresponding to an informing device designated in informing data described later, and notifies the content of informing corresponding to the determination result. In addition, herein, when determining the receiver sensitivity in the mobile terminal 1, the control section 11 monitors the amount of current passed through the coil corresponding to the electromagnetic wave from the external R/W 2, but the method of determining the receiver sensitivity is not limited thereto, and is capable of being modified as appropriate.

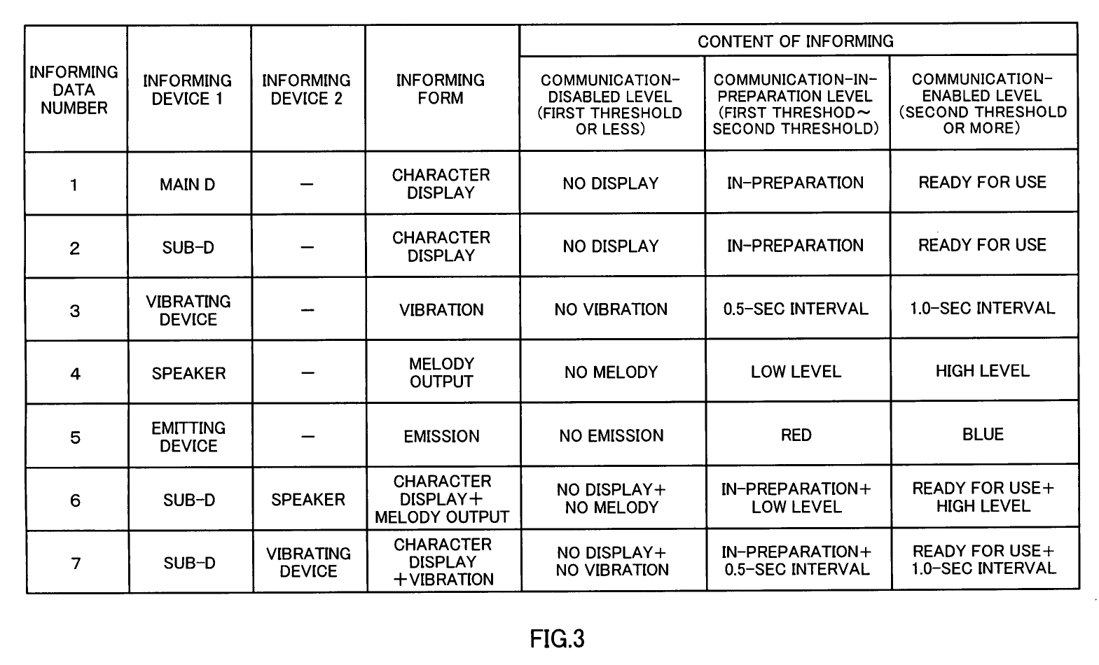

The storage section 15 stores the threshold data to be referred to by the control section 11 in determining the receiver sensitivity in the mobile terminal 1, while further storing the informing data table with which is registered the content of informing corresponding to the receiver sensitivity determined using the threshold data. FIG. 3 is a diagram showing an example of the informing data table managed in the storage section 15. In addition, FIG. 3 shows the case where two items of threshold data (first threshold data and second threshold data) are set as the threshold data referred to in determining the receiver sensitivity in the mobile terminal 1.

As shown in FIG. 3, in the informing data table, each informing data is assigned a number (informing data number), and registered with each data are a device (hereinafter, referred to as an “informing device”) to perform informing, informing form, and the content of informing corresponding to the receiver sensitivity. One of structural components in the informing section 14 is designated as the informing device, and a form of informing according to the informing device is designated as the informing form. The content of informing is divided into three items to be designated. In other words, the content is divided into a case (hereinafter, referred to as a “case of communication-disabled level”) where an amount of current used in the determination of the receiver sensitivity is less than or equal to the first threshold data, another case (hereinafter, referred to as a “case of communication-in-preparation level”) where the amount of current is in between the first threshold data and the second threshold data, and still another case (hereinafter, referred to as a “case of communication-enabled level”) where the current is more than or equal to the second threshold data.

The display control section 131, vibration control section 132, sound control section 133, and emission control section 134 in the informing control section 13 control respective informing devices (display 141, vibrating device 142, speaker 143 and emitting device 144) corresponding to the content of informing notified from the control section 11. In other words, the display control section 131 causes the display 141 to display the content of display according to the receiver sensitivity, the vibration control section 132 causes the vibrating device 142 to vibrate according to the receiver sensitivity, the sound control section 133 causes the speaker 143 to output the sound according to the receiver sensitivity, and the emission control section 134 causes the emitting device 144 to emit the light according to the receiver sensitivity.

Referring to the content of the informing data table as shown in FIG. 3, described herein is the content of informing in the mobile terminal 1. In informing data (hereinafter, referred to as “informing data 1” as appropriate) of informing data number 1, the main display 1411 is set as the informing device, and character display is set as the informing form. Therefore, for example, when the informing data 1 is selected by the input section 16, character display is performed in the main display 1411 in a different mode according to the receiver sensitivity. Set as the content of informing is such content that characters are not displayed when the receiver sensitivity is of the communication-disabled level, characters of “in-preparation” are displayed when the receiver sensitivity is of the communication-in-preparation level, and that characters of “ready for use” are displayed when the receiver sensitivity is of the communication-enabled level. Thus, by checking character display in the main display 1411, the user is capable of grasping the position over the external R/W 2 where the receiver sensitivity is good in the mobile terminal 1. In addition, informing data 2 is the same as the informing data 1 except the informing device being the sub-display 1412.

In informing data 3, the vibrating device 142 is set as the informing device, and vibration is set as the informing form. Therefore, for example, when the informing data 3 is selected by the input section 16, the vibrating device 142 vibrates in a different mode according to the receiver sensitivity. Set as the content of informing is such content that vibration is not carried out when the receiver sensitivity is of the communication-disabled level, the vibrating device 142 vibrates at intervals of “0.5 second” when the receiver sensitivity is of the communication-in-preparation level, and that the vibrating device 142 vibrates at intervals of “1.0 second” when the receiver sensitivity is of the communication-enabled level. By this means, by checking vibration of the vibrating device 142, the user is capable of grasping the position over the external R/W 2 where the receiver sensitivity is good in the mobile terminal 1.

In informing data 4, the speaker 143 is set as the informing device, and an output of melody is set as the informing form. Therefore, for example, when the informing data 4 is selected by the input section 16, the melody is output from the speaker 143 in a different mode according to the receiver sensitivity. Set as the content of informing is such content that the melody is not output when the receiver sensitivity is of the communication-disabled level, the melody is output “at a low-volume level” when the receiver sensitivity is of the communication-in-preparation level, and that the melody is output “at a high-volume level” when the receiver sensitivity is of the communication-enabled level. Thus, by checking the output of melody, the user is capable of grasping the position over the external R/W 2 where the receiver sensitivity is good in the mobile terminal 1.

In informing data 5, the emitting device 144 is set as the informing device, and emission is set as the informing form. Therefore, for example, when the informing data 5 is selected by the input section 16, the emitting device 144 emits the light in a different mode according to the receiver sensitivity. Set as the content of informing is such content that emission is not carried out when the receiver sensitivity is of the communication-disabled level, the emitting device 144 emits the light of “red” when the receiver sensitivity is of the communication-in-preparation level, and that the emitting device 144 emits the light of “blue” when the receiver sensitivity is of the communication-enabled level. By this means, by checking a color of the light in the emitting device 144, the user is capable of grasping the position over the external R/W 2 where the receiver sensitivity is good in the mobile terminal 1.

Further, in the informing data registered with the informing data table, it is possible to combine two or more informing forms. For example, in informing data 6, the sub-display 1412 and the speaker 143 are set as the informing device, and character display and melody output is set as the informing form. Therefore, for example, when the informing data 6 is selected by the input section 16, character display is performed in the sub-display 1412 in a different mode according to the receiver sensitivity, while the melody is output from the speaker 143 in a different mode. Set as the content of informing is such content that character display and melody output is not carried out when the receiver sensitivity is of the communication-disabled level, characters of “in-preparation” are displayed while the melody is output “at a low-volume level” when the receiver sensitivity is of the communication-in-preparation level, and that characters of “ready for use” are displayed while the melody is output “at a high-volume level” when the receiver sensitivity is of the communication-enabled level. Thus, by checking the display in the sub-display 1412 and the output of melody from speaker 143, the user is capable of grasping the position over the external R/W 2 where the receiver sensitivity is good in the mobile terminal 1.

In addition, the content of the informing data as shown in FIG. 3 shows an example, and is capable of being modified as appropriate, for the purpose of informing a user of the receiver sensitivity to easily understand. In the example as shown in FIG. 3, it is possible to optionally set characters (informing data 1) displayed in the main display 1411, the time (informing data 2) during which the vibrating device 142 vibrates, the sound and the like (informing data 3) output from the speaker 143, the color (informing data 4) of light emitted from the emitting device 144, and the like. In particular, for the display 141 suitable for the form of informing, it is possible to inform the user of the content corresponding to the receiver sensitivity in a mode of combining an image and characters, in a mode having only an image, and the like. It is also possible to cause the user to set the content of informing optionally using the input section 16.

Further, while FIG. 3 shows the case where two items of threshold data are set, the number of settings of threshold data can be modified as appropriate. When a plurality of items of threshold data is set, it is preferable that the content of informing is set corresponding to the number of settings. For example, as an embodiment, it is preferable that as shown in FIG. 3, a plurality of items of threshold data is set, and that the content of informing is set to guide the mobile terminal 1 to the position over the external R/W 2 where the receiver sensitivity is the highest. When such content of informing is set, it is made possible to guide the mobile terminal 1 to the position where the electromagnetic wave from the external R/W 2 is suitably received, through the content of informing, and the user is thereby capable of grasping the position easily and reliably.

As the content of informing to guide the mobile terminal 1 to the position over the external R/W 2 where the receiver sensitivity is the highest, when characters are displayed in the sub-display 1412, it is considered that the characters are changed to be displayed corresponding to the distance to the position over the external R/W 2 where the receiver sensitivity is the highest. In this case, it is assumed to display characters showing a remaining distance (for example, “2 cm more” or the like) to reach the position over the external R/W 2 where the receiver sensitivity is the highest. When such content of informing is set, it is made possible to guide the mobile terminal 1 to the position where the electromagnetic wave from the external R/W 2 is suitably received, through the content of informing corresponding to the distance, and the user is thereby capable of recognizing the distance to such a position at first glance by checking display in the sub-display 1412, and of grasping the position more easily and reliably. In addition, as an example of the content of informing to guide the mobile terminal 1 to the position where the receiver sensitivity is the highest, the case is described herein that the informing form is the character display in the sub-display 1412, but such content is applicable to other structural components in the informing section 14. For example, when the informing form is the sound output in the speaker 143, it is considered that a speech is output to teach a remaining distance (for example, “2 cm more” or the like) to reach the position over the external R/W 2 where the receiver sensitivity is the highest.

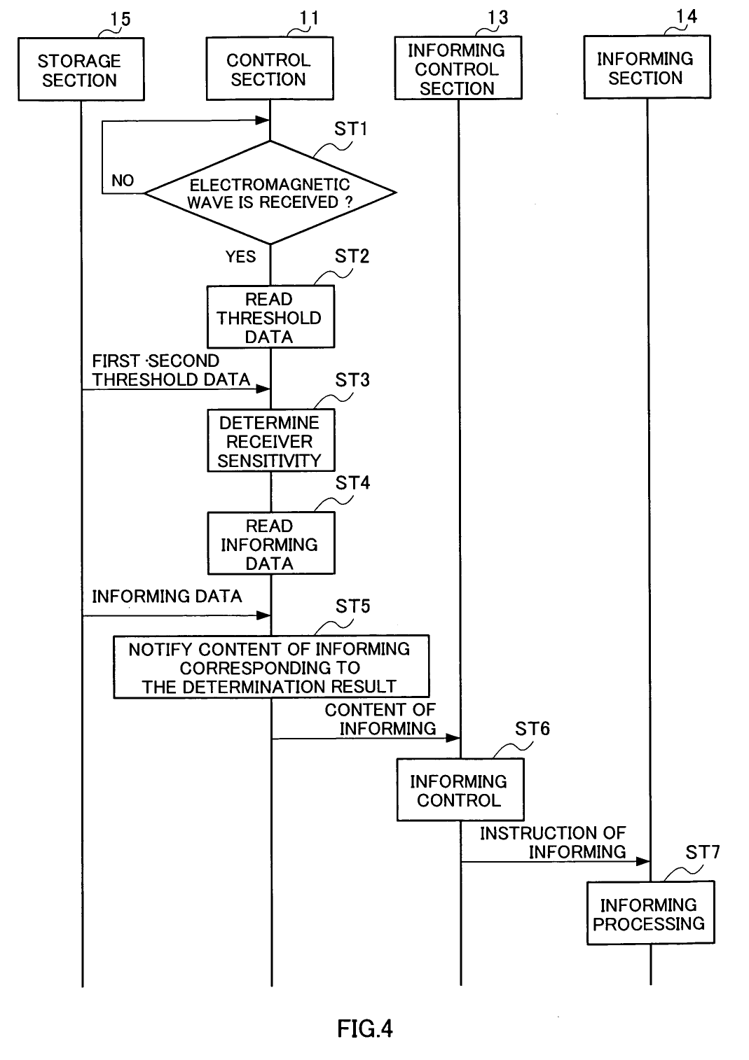

Referring to FIG. 4, the processing will be described below when the user is informed of the receiver sensitivity in the mobile terminal device having the above-mentioned configuration. FIG. 4 is a sequence diagram to explain the processing for informing a user of the receiver sensitivity in the mobile terminal device according to this embodiment.

In the mobile terminal 1, the IC card section 12 is always in a state of waiting for an electromagnetic wave transmitted from the external R/W 2 installed in a store or the like, and the control section 11 monitors the amount of current passed through the coil of the IC card section 12 corresponding to the electromagnetic wave from the external R/W 2, and thereby monitors whether the electromagnetic wave is received from the external R/W 2 (ST1). When judging that the electromagnetic wave is received, the control section 11 reads the threshold data (herein, the first threshold and the second threshold) out of the storage section 15 (ST2). Then, the control section 11 judges the receiver sensitivity determined corresponding to the electromagnetic wave received from the external R/W 2 (ST3). More specifically, the control section 11 determines the receiver sensitivity by comparing the amount of current passed through the coil of the IC card section 12 by the electromagnetic wave received from the external R/W 2 with the first threshold data and second threshold data.

After determining the receiver sensitivity, the control section 11 reads the informing data from the storage section 15 (ST4). Then, the control section 11 extracts the informing device and the content of informing from the read informing data, and notifies the content of informing according to the determination result to the control section in the informing control section 13 corresponding to the extracted informing device of (ST5) According to the content of informing notified from the control section 11, the corresponding control section in the informing control section 13 performs informing control on the informing device under its control (ST6) More specifically, the control section instructs the informing device under its control to inform the content of informing according to the determination result (instruction of informing ). The informing device receiving the instruction of informing performs the informing processing corresponding to the content of informing included in the instruction of informing (ST7) In the mobile terminal 1, the processing between reception of the electromagnetic wave and the informing processing is continued for a period during which the electromagnetic wave is received. The user moves the position of the mobile terminal 1 while checking thus informed content of informing, and is thereby capable of grasping the position over the external R/W 2 where the receiver sensitivity is good in the mobile terminal 1.

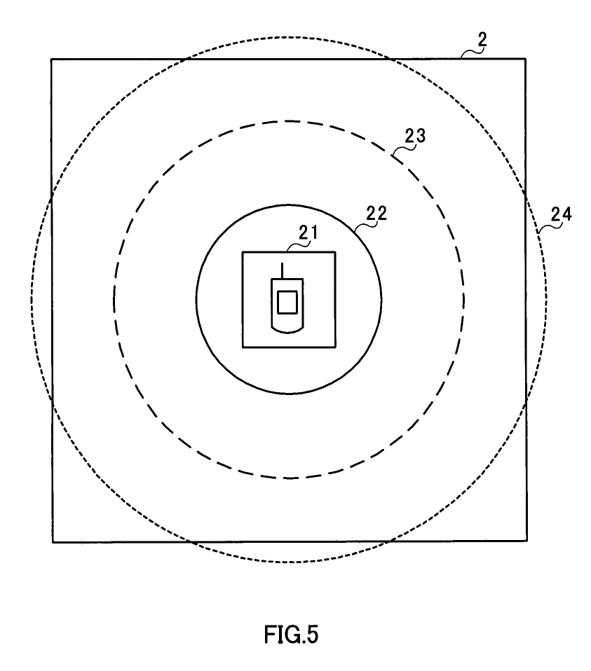

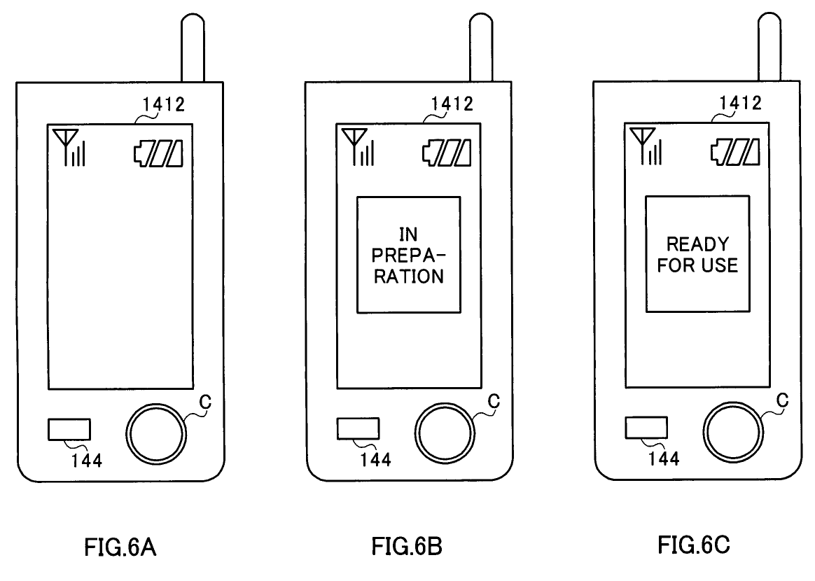

The content informed according to the sequence as shown in FIG. 4 is specifically described herein with reference to the informing data as shown in FIG. 3, and FIGS. 5 and 6. In addition, the case is described herein that the informing data 2 as shown in FIG. 3 is selected by the user.

FIG. 5 is a diagram illustrating an appearance of the external R/W 2, and FIG. 6 is a diagram illustrating an appearance of the mobile terminal 1 that is closed. As shown in FIG. 5, a mark 21 that is a target to hold the mobile terminal 1 is put on the center on the surface of the external R/W 2. Further, in the vicinity of the surface of the external R/W 2, a region (communication-enabled level region) 22 where the receiver sensitivity in the mobile terminal 1 is of the communication-enabled level is formed around the mark 21 as a center, another region (communication-in-preparation level region) 23 where the receiver sensitivity is of the communication-in-preparation level is formed outward the communication-enabled level region 22, and still another region (communication-disabled level region) 24 where the receiver sensitivity is of the communication-disabled level is formed outward the communication-in-preparation region 23. Further, as shown in FIG. 6A, on the external surface of the mobile terminal 1 are provided the sub-display 1412, and the emitting device 144 and an image pickup device C near the sub-display 1412.

In the process of performing the processing according to the sequence as shown in FIG. 4, when the determination of the receiver sensitivity in the mobile terminal 1 is made in ST3, the control section 11 reads the informing data from the storage section 15 (ST4), and extracts the informing device and the content of informing from the informing data. Herein, the informing data 2 is read, the sub-display 1412 is extracted as the informing device, and information of characters corresponding to each receiver sensitivity is extracted as the content of informing. Then, the control section 11 notifies the display control section 131 associated with the sub-display 1412 of the content of informing corresponding to the determination result of the receiver sensitivity (ST5). In other words, the control section 11 notifies that information of characters subject to display is not present when the receiver sensitivity is of the communication-disabled level, that information of characters subject to display is “in-preparation” when the receiver sensitivity is of the communication-in-preparation level, and that information of characters subject to display is “ready for use” when the receiver sensitivity is of the communication-enabled level.

Upon receiving notification of the content of informing, the display control section 131 controls display of the sub-display 1412 corresponding to the content of informing (ST6). More specifically, the control section 131 instructs display of the content of informing according to the determination result of the receiver sensitivity. The sub-display 1412 receiving the instruction displays the content of informing included in the instruction (ST7). For example, when the mobile terminal 1 is positioned in the communication-disabled level region 24 as shown in FIG. 5, as shown in FIG. 6A, characters are not displayed in the sub-display 1412. Then, the mobile terminal 1 is shifted to inside the communication-in-preparation level region 23 as shown in FIG. 5, as shown in FIG. 6B, characters of “in-preparation” are displayed in the sub-display 1412. Further, when the mobile terminal 1 is shifted to inside the communication-enabled-level region 22 as shown in FIG. 5, as shown in FIG. 6C, characters of “ready for use” are displayed in the sub-display 1412. Accordingly, the user shifts the position of the mobile terminal 1 over the external R/W 2 while checking characters thus displayed in the sub-display 1412, and is thereby capable of grasping the position over the external R/W 2 where the receiver sensitivity is good in the mobile terminal 1.

Thus, in the mobile terminal 1 according to this embodiment, the terminal 1 receives an electromagnetic wave from the external R/W 2, determines the receiver sensitivity in the terminal 1 corresponding to the electromagnetic wave, and informs the user of a different item of content corresponding to the receiver sensitivity. Therefore, by setting the content of informing corresponding to the receiver sensitivity, it is possible to cause the user to grasp the position where the electromagnetic wave from the external R/W 2 is suitably received. Then, by communicating with the external R/W 2 in the position, it is possible to exchange the information required for subsequent provision of service without inadequacies, and the user is thereby capable of using the service promptly and reliably.

Particularly, in the mobile terminal 1 according to this embodiment, informed is the content (for example, “ready for use” of the informing data 1 as shown in FIG. 3) enabling a grasp of the position over the external R/W 2 where the receiver sensitivity in the terminal 1 is the highest. It is thereby possible to cause the user to reliably grasp the position where the electromagnetic wave from the external R/W 2 is suitably received according to the content of informing.

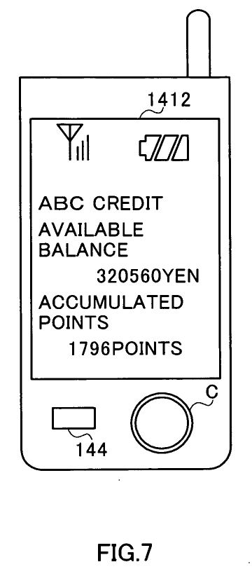

In addition, the above-mentioned embodiment describes the case where as the content to inform the user, the content corresponding to the receiver sensitivity in the mobile terminal 1 is informed to the user. However, the content to inform the user is not limited to the content corresponding to the receiver sensitivity, and may include information corresponding to the content of subsequent service. For example, when the content of subsequent service is electronic payment service and the receiver sensitivity in the mobile terminal 1 is informed in the sub-display 1412 (herein, FIG. 6 is assumed), as shown in FIG. 7, substituting for display of characters as shown in FIG. 6C, information may be displayed such as the balance available in the electronic payment service, and the like. In this case, it is possible to check the information corresponding to the content of subsequent service, while grasping the position over the external R/W 2 where the receiver sensitivity in the mobile terminal 1 is good. It is thereby possible to reduce the number of times of checking processing in the user, and to further improve the operability in using the proximity card function.

The present invention is not limited to the above-mentioned embodiment, and is capable of being carried into practice with various modifications thereof. For example, the above-mentioned embodiment describes the case where the proximity card function is FeliCa, but the invention is similarly applicable to cases where the proximity card function is any proximity card function other than FeliCa. Further, the invention is capable of being carried into practice in a modification thereof as appropriate without departing from the scope of the invention.

For example, the above-mentioned embodiment describes the case of informing the user of a different item of content corresponding to the receiver sensitivity of the device determined corresponding to the electromagnetic wave from the external R/W 2 disposed in a store and the like of a service provider that provides service to the mobile terminal device. However, the mode of the external R/W 2 is not limited to this case, and the invention is applicable to other modes. For example, the invention is applicable to a mode where the reader/writer (R/W) function similar to the external R/W 2 is installed in the mobile terminal device and the like. In this case, when mobile terminal devices communicate information and the like with each other using the proximity IC card function, each of the devices is capable of grasping the position with the good receiver sensitivity, and of communicating the information suitably.

This application is based on the Japanese Patent Application No. 2005-256348 filed on Sep. 5, 2005, the entire content of which is expressly incorporated by reference herein.

What is claimed is:

1. A mobile terminal device that performs communication with an external reader/writer in a noncontact manner, comprising:
a receiver that receives an electromagnetic wave from the reader/writer;
a determiner that determines a receiver sensitivity of the device corresponding to the electromagnetic wave; and
an informing section that informs a user of a different item of content corresponding to the receiver sensitivity of the device.

2. The mobile terminal device according to claim 1, wherein the informing section informs the content enabling a grasp of a position over the reader/writer where the receiver sensitivity of the device is the highest.

3. The mobile terminal device according to claim 2, wherein the informing section informs the content to guide the device to the position over the reader/writer where the receiver sensitivity of the device is the highest.

4. The mobile terminal device according to claim 3, wherein the informing section informs the content corresponding to a distance to the position over the reader/writer where the receiver sensitivity of the device is the highest.

5. The mobile terminal device according to claim 1, wherein the informing section has a display that displays the content corresponding to the receiver sensitivity of the device, a vibrator that vibrates corresponding to the receiver sensitivity of the device, a sound output section that outputs a sound corresponding to the receiver sensitivity of the device, an emitter that emits light corresponding to the receiver sensitivity of the device, or a combination thereof.

6. The mobile terminal device according to claim 5, further comprising:
an input section that receives an input of operation of a user,
wherein the informing section informs the content using the display, the vibrator, the sound output section, the emitter or a combination thereof, according to an instruction from the user received via the input section.

7. The mobile terminal device according to claim 1, further comprising:
a storage that stores threshold data used in determining the receiver sensitivity of the device, wherein the determiner determines the receiver sensitivity of the device based on the threshold data.

8. The mobile terminal device according to claim 7, wherein the storage stores a plurality of items of threshold data, and the determiner determines the receiver sensitivity of the device by comparison with the plurality of items of threshold data.

9. A method of informing a receiver sensitivity in a mobile terminal device that performs communication with an external reader/writer in a noncontact manner, wherein an electromagnetic wave is received from the reader/writer, a receiver sensitivity of the device is determined corresponding to the electromagnetic wave, and a user is informed of a different item of content corresponding to the receiver sensitivity of the device.

10. The method of informing a receiver sensitivity according to claim 9, wherein informed is the content enabling a grasp of a position over the reader/writer where the receiver sensitivity of the device is the highest.

11. The method of informing a receiver sensitivity according to claim 10, wherein informed is the content to guide the device to the position over the reader/writer where the receiver sensitivity of the device is the highest.

12. The method of informing a receiver sensitivity according to claim 11, wherein informed is the content corresponding to a distance to the position over the reader/writer where the receiver sensitivity of the device is the highest.

13. The method of informing a receiver sensitivity according to claim 9, wherein the content is informed using a display that displays the content corresponding to the receiver sensitivity of the device, a vibrator that vibrates corresponding to the receiver sensitivity of the device, a sound output section that outputs a sound corresponding to the receiver sensitivity of the device, an emitter that emits light corresponding to the receiver sensitivity of the device, or a combination thereof.

14. The method of informing a receiver sensitivity according to claim 13, wherein the content is informed using the display, the vibrator, the sound output section, the emitter or a combination thereof, according to an instruction received from the user.

15. The method of informing a receiver sensitivity according to claim 9, wherein threshold data used in determining the receiver sensitivity of the device is stored, and the receiver sensitivity of the device is determined based on the threshold data.

16. The method of informing a receiver sensitivity according to claim 15, wherein a plurality of items of threshold data is stored, and the receiver sensitivity of the device is determined by comparison with the plurality of items of threshold data.
